(19) United States
(12) Patent Application Publication
(10) Pub. No.: US 2019/0102920 A1
(43) Pub. Date: Apr. 4, 2019

(54) JOINTLY ESTIMATING THE HURST EXPONENT AND VOLATILITY OF TIME SERIES

(71) Applicant: Ul Lusenn, Roscanvel (FR)

(72) Inventors: Josselin Gilbert Garnier, Paris (FR); Knut Solna, Irvine, CA (US)

(21) Appl. No.: 15/880,953

(22) Filed: Jan. 26, 2018

(30) Foreign Application Priority Data
Oct. 2, 2017 (FR) 1771041

(51) Int. Cl. G06T 11/20; G06F 17/30; G06Q 40/04

(52) U.S. Cl. CPC G06T 11/206; G06Q 40/04; G06F 17/30548

(57) ABSTRACT

A method comprising: in a computer system having at least a processor and a memory, the memory having at least an operating system, using wavelets to form a scale spectrum; and computing estimated Hurst and volatility parameters derived from the scale spectrum.

### BACKGROUND

The present invention relates generally to the prices of commodities or other assets, and more particularly to jointly estimating the Hurst exponent and the volatility of time series.

In general, prices of commodities or assets produce what is called a time series. All transactions on a financial market are recorded, leading to a huge amount of data available. Financial time series analysis is of great interest to practitioners as well as to theoreticians, for making inferences and predictions. Furthermore, the stochastic uncertainties inherent in financial time series and the theory needed to deal with them make the subject especially interesting not only to economists, but also to statisticians and physicists.

### SUMMARY

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention relates generally to the prices of commodities or other assets, and more particularly to jointly estimating the Hurst exponent and the volatility of time series. The method described herein is designed to deal with financial time series. It is based on time-frequency decomposition, making it possible to estimate time-varying parameters. Specifically, Haar wavelets are used in the estimation in order to form a scale spectrum, and the estimated Hurst and volatility parameters derive from this.

In an aspect, the invention features a method comprising: in a computer system having at least a processor and a memory, the memory having at least an operating system, using wavelets to form a scale spectrum; and computing estimated Hurst and volatility parameters derived from the scale spectrum.

The wavelets may be selected from the group consisting of Han wavelets and Daubechies wavelets.

Hurst exponent and volatility parameters may jointly describe a statistical character of data vectors possessing local power law spectra.

In another aspect, the invention features a method comprising:

in a computer systems having at least a processor and a memory, the memory having at least an operating system, computing Haar wavelet coefficients, the Haar wavelet coefficients representing local averages of a data vector, the computing done at all possible averaging lengths and all possible center points for an averaging window;

for each location of the window, computing an energy (mean square value) of the Haar coefficients whose center points are within the window, computing the energy (mean square value) of the Haar coefficients determined separately for each group of Haar coefficients, based on a certain averaging length, the energy as a function of the Haar coefficient averaging length referred to as a scale spectrum; and

computing Hurst coefficient and volatility as a function of the moving window's center point derived from a slope and an intercept of the scale spectrum in a log-log plot.

The scale spectrum in the log-log plot may be a log energy of the Haar coefficients as a function of the log of the averaging length for the Haar coefficients.

In another aspect, the invention features an architecture comprising:

a network of interconnected computers; and

a link from the network to a computing device, the computing device having at least a processor and a memory, the memory having at least an operating system and a process to determine for jointly estimating a Hurst exponent and a volatility of time series, the process comprising:

computing Haar wavelet coefficients, the Haar wavelet coefficients representing local averages of a data vector, the computing done at all possible averaging lengths and all possible center points for an averaging window;

for each location of the window, computing an energy (mean square value) of the Haar coefficients whose center points are within the window, computing the energy (mean square value) of the Haar coefficients determined separately for each group of Haar coefficients, based on a certain averaging length, the energy as a function of the Haar coefficient averaging length referred to as a scale spectrum; and

computing Hurst coefficient and volatility as a function of the moving window's center point derived from a slope and an intercept of the scale spectrum in a log-log plot.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The invention will be more fully understood by reference to the detailed description, in conjunction with the following figures, wherein:

FIG. 1A is a block diagram.

FIG. 1B is flow diagram.

FIG. 2 is an exemplary graph.

FIG. 3 is an exemplary graph.

FIG. 4 is an exemplary graph.

FIG. 5 is an exemplary graph.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

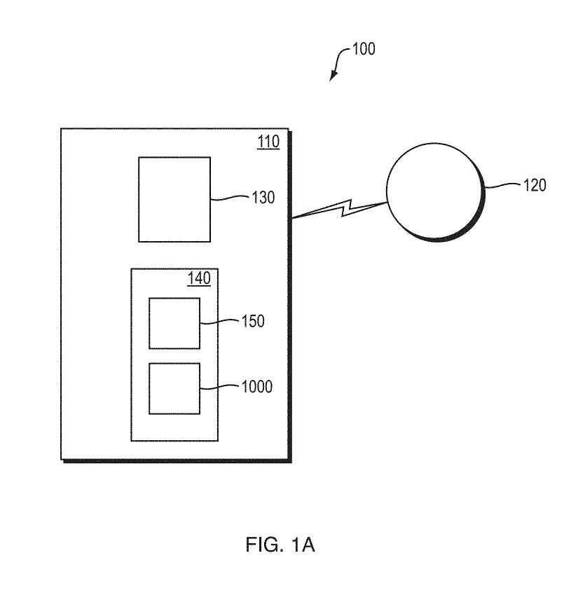

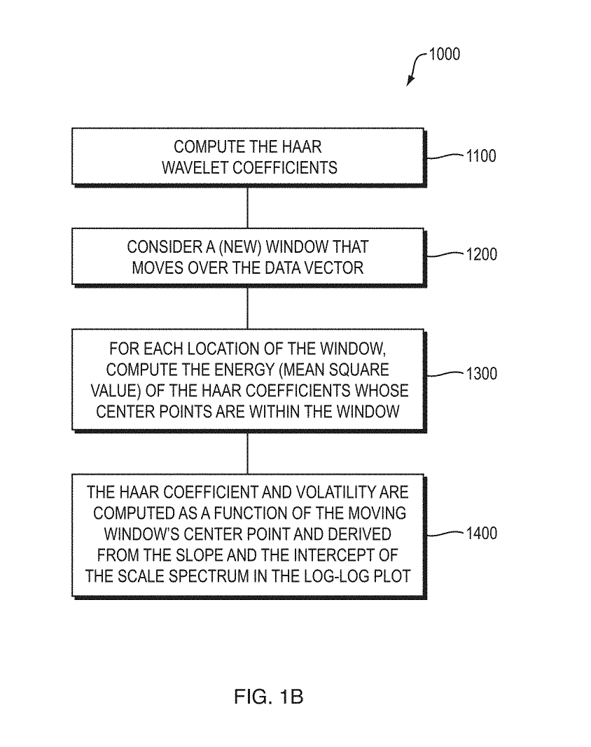

As shown in FIG. 1A, an exemplary system 100 includes a computing device 110 communicatively linked to a network of interconnected computers (e.g., the Internet) 120. The computing device 110 includes at least a processor 130 and a memory 140. The memory 140 includes at least an operating system 150, such as Windows®, iOS® or Linux®, and a process 1000 for jointly estimating the Hurst exponent and the volatility of time series.

From a financial perspective, it is important to understand the local character of financial time series, for instance of daily oil prices. Below, we refer to the underlying time series as the data vector. We present herein a procedure for estimating this local character. The local character in our framework is given by the Hurst exponent and volatility. These two parameters jointly describe the local character of the data vectors assuming they possess local power law spectra. For realistic financial data vectors, the local character varies with time, and hence these two parameters also vary with time. Since the two parameters are important in various financial applications, it is essential to have robust methods to estimate them. We present here a novel procedure for jointly estimating the Hurst exponent and volatility and their variations with time.

In “classic” finance, one of the most important parameters is volatility. In fact, in so-called efficient markets, the Hurst exponent is supposed to be equal to the efficient market value of one-half. A focus on efficient markets has led to a lack of tools for detecting, characterizing and responding to periods of temporarily inefficient markets.

Consider four markets:
1. Commodity markets (e.g., oil and gas markets)
2. Equity markets (e.g., stocks and indices)
3. Foreign exchange markets
4. Fixed income markets

Example users of the methods described herein can be as follows.

### Front Office Traders

The traders can use our characterization of the current market situation for three main purposes. First, they can price derivative contracts based on financial assets whose parameters have been identified via our process. The fair price will depend significantly on the estimated parameters, the Hurst exponent and volatility. The fair price can be computed, for instance, via Monte Carlo simulations.

Second, the trader can use our model to design a trading (hedging) scheme that is designed to replicate (or approximately follow) prices for certain derivatives, and, therefore, can be used as a tool for constructing a portfolio to reduce risk. The hedging scheme will significantly depend on the two parameters, the volatility and the Hurst coefficient, associated with the financial assets underlying the portfolio.

Third, a trader may want to construct a portfolio of financial instruments “optimally” designed to grow in value while balancing the risk for loss. To understand the nature or behavior of the underlying assets and the opportunities they provide for growth or gain the estimation of the two parameters, the volatility and the Hurst coefficient, is again essential.

### Back Office Risk Management Quants

First, with regular intervals, the risk of the firm's portfolio needs to be quantified. This risk changes fundamentally if, for instance, the markets move into a situation of inefficiency. Our estimation of the power law parameters provides an important input to the firm's basic risk management strategy. Specifically, to compute quantities like the value of risk or how much the value of a portfolio can go down with a certain probability, the management quants need the two parameters, the volatility and the Hurst coefficient.

Second, while working on developing investment strategies used by the front office, the back office needs to model the dynamics or typical evolution paths of the underlying assets. Again to do this estimation of the volatility and Hurst coefficient and how they have evolved in the past and then may evolve in the future is essential.

### Insider Trading Trackers

The detection of temporarily inefficient market behavior with a Hurst parameter larger than ½ (or different from ½) can be the manifestation of insider trading or market manipulation. The monitoring of the Hurst parameter can be seen as an instrument for detecting such behaviors.

Referring now to FIG. 1B, the process 1000 for jointly estimating the Hurst exponent and the volatility of time series includes computing (1100) the Haar wavelet coefficients, which are local averages of the data vector. This is done at all possible averaging lengths and all possible center points for the averaging window. Special care needs to be paid to windows near the end points of the data vector. Other wavelets, such as Daubechies wavelets, can also be used.

Process 1000 considers (1200) a (new) window that moves over the data vector. For each location of the window, process 1000 computes (1300) the energy (mean square value) of the Haar coefficients whose center points are within the window. This calculation is made separately for each group of Haar coefficients, which is based on a certain averaging length. This energy, as a function of the Haar coefficient averaging length, is what we refer to herein as the scale spectrum. The scale spectrum in a log-log plot is essentially the log energy of the Haar coefficients as a function of the log of the averaging length for the Haar coefficients. Other representations, as a function of the inverse of the Haar coefficient averaging length for instance, are also possible.

In process 1000, for each center point of the moving window, we now have a scale spectrum. In the case that the underlying data vector comes from a “power law,” this scale spectrum will be linear in a log-log plot. The Hurst coefficient and volatility are then computed (1400) as a function of the moving window's center point and derives from the slope and the intercept of the scale spectrum in the log-log plot. Roughly, the volatility corresponds to the height (or intercept) of the scale spectrum and the Hurst exponent to the slope.

In the field of atmospheric turbulence, a wavelet-based estimator of the Hurst exponent alone was introduced in the past and subsequently applied to financial data. The method described herein distinguishes itself from that at least in several ways. First we estimate jointly the Hurst exponent and volatility. Second, we use the Haar coefficients differently, in that, we use all scales as averaging lengths for the Haar coefficients and not only the dyadic scales: 2^{j}; j=1, 2, . . . . Third, we correspondingly get a scale spectrum over all scales and not only dyadic scales. Fourth, we use an original weighting of the data in the scale spectrum when we estimate the Hurst and volatility parameters. Fifth, we use a new approach for handling the data close to the boundaries of the moving window.

### Oil Price Data Example

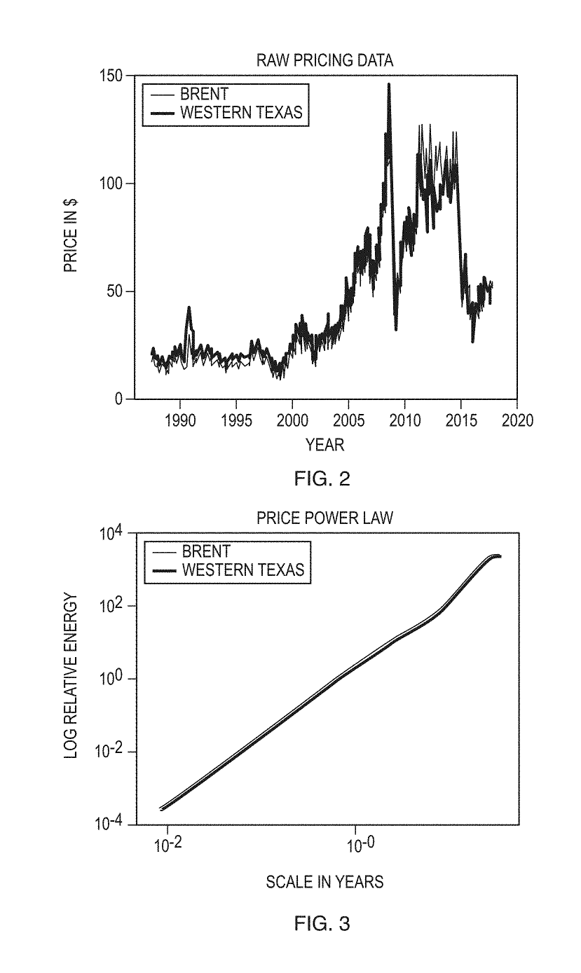

In FIG. 2, the red dashed line shows the raw daily oil price data vector for “West Texas Intermediate (WTI), Spot Price Free On Board (FOB) (New York)” (hereafter “West Texas”) in dollars per barrel. The solid blue line represents the “Europe Brent Spot Price FOB (London)” (hereafter “Brent”) in dollars per barrel. The daily data are available from May 1987 to September 2017.

We show in FIG. 3, the scale spectra for the complete log-transformed data (using only one window). The first level Haar coefficients correspond to the consecutive differences in the data. The Haar coefficients at higher levels correspond to differences in local averages of increasing length. The scale spectrum shows the energy of these coefficients at the different scales or frequencies. The FIG. 3 shows a global power law with a specific slope and intercept.

We compute the scale spectrum with respect to a moving window, as described above. The slope and the intercept vary with respect to the window's location. The Hurst exponent and volatility then derive from the slope and the intercept for each window location; they therefore become vectors indexed by time (which can be the window's center point). These derived vectors are the central quantities used by traders. Here and in the next figure, the West Texas data set corresponds to the red dashed line and the Brent data set to the solid blue line.

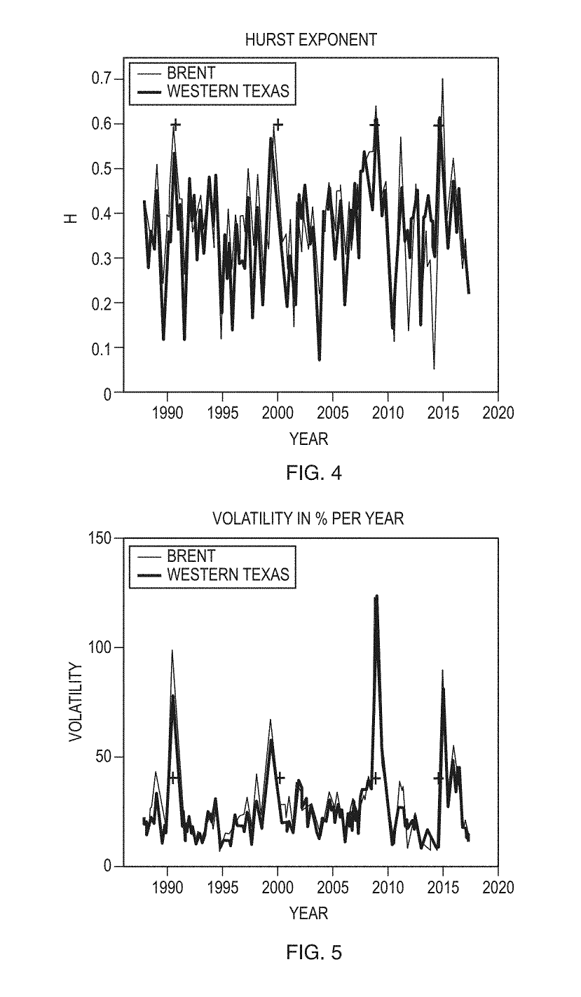

In FIG. 4, we present the estimated Hurst exponent vector Hₜ. We remark that large values (larger than ½) are of particular interest here and correspond to a so-called inefficient market situation. Information about the emergence of such inefficient periods is crucial to traders.

Using the same segmentation as in FIG. 4 and our joint estimation procedure, we give the corresponding volatility estimate σₜ in FIG. 5.

FIG. 4 and FIG. 5 clearly illustrate that there are four periods: roughly, 1990-1991, 1999{-2000, 2008-2009, and 2014-2015, with relatively high parameter values. These four periods can be related to four events, marked with crosses in FIG. 4 and FIG. 5.
The first cross, in August 1990, corresponds to Iraq's invasion of Kuwait, and it initiates a period with high volatility and a high Hurst exponent.
The second cross, in January 2000, corresponds to the peak of a period with relatively high volatility and a high Hurst exponent. This may be explained by the approach of the year 2000 and fear of the Y2K bug that never occurred.
The third cross, in September 2008, corresponds to the bankruptcy of Lehman Brothers, initiating a period with very high volatility and a high Hurst exponent. We can also note that the all-time high for oil prices was reached during trading on 11 Jul. 2008.
The fourth cross, in July 2014, corresponds to the massive liquidation of Brent- and WTI-linked derivatives by fund managers and the beginning of the price fall, initiating a period with a very high Hurst exponent and high volatility.

Note that these special periods cannot easily be seen in the raw oil prices themselves in FIG. 2, yet, as mentioned, they provide fundamentally important information for the traders.

The following explains the details of how the scale spectrum and the local power law parameters are calculated from the data vector (price data).

### Input Parameters

The input parameters are:
i) The price data (data vector) at times tn denoted by {P(tn),n=1, . . . , N} are given, where tn=t0+nΔt.
ii) The integers ji, je that determine the scale range under consideration, the inertial range. The inertial range is the scale range over which we look for a power law.

iii) The window size M that is the size of the time windows in which the local spectra are computed. We must have 1≤ji≤je≤M/2. Default values for ji, je, and M can be determined automatically from the size N of the data vector.

It is possible to estimate the power law parameters for all center times tn0, n0=1, . . . , N. We first give in the next subsection the general algorithm for the interior center times n0∈M/2, . . . , N−M+M/2, and then we extend it to the boundary center times n0∈{1, . . . , M/2−1}∪{N−M+M/2+1, . . . , N}.

### Interior Center Times

Let us fix the center-time index n0∈M/2, . . . , N−M+M/2 and proceed as follows:
1. Compute the log-transformed data Q=(Qⱼ)ⱼ₌₁^{M} centered at tn0 by:

Qⱼ=log(P(t_{n0-└M/2┘+j})), j=1, . . . ,M
2. Compute the scale spectrum S=(Sⱼ)ⱼ₌ⱼ_{ᵢ}^{j}^{ₑ} as the local mean square of the wavelet coefficients:

$${S}_{j} = \frac{{\sum }_{i = 1}^{N} {( {d}_{j} ( i ) )}^{2}}{{N}_{j}}$$

$$where$$

$${N}_{j} = M - 2 j + 1$$

$${d}_{j} ( i ) = \frac{{\sum }_{i = 1}^{j} ( {Q}_{i} - {Q}_{i + j} )}{\sqrt{2 j}}$$

4. Compute the regression parameters \hat{b}=(ĉ,\hat{p})^{T} defined by

\hat{b}=(x^{T}R⁻¹X)⁻¹X^{T}R⁻¹Y
5. Compute the local Hurst exponent and volatility as

$$\hat{H} ( {t}_{n 0} ) = \frac{\hat{p} - 1}{2}$$

$$\hat{σ} ( {t}_{n 0} ) = \frac{{2}^{\hat{c} / 2}}{\sqrt{h ( \hat{H} ( {t}_{n 0} ) )}}$$

In these equations:
The dj(i)s correspond to the “continuous transform Haar wavelet detail coefficients”.
The matrix X is the design matrix, R the approximated covariance matrix, and Y the data vector for the generalized least squares problem that makes it possible to identify the local power law parameters.
In the definition of Ĥ(tₙ₀), we can set a threshold on the estimation by min(max(Ĥ(tₙ₀), 0.05), 0.95), in order to avoid any singular behavior.
The scale-spectral scaling function h is defined by

$$h ( H ) = \frac{( 1 - {2}^{- 2 H} )}{( 2 H + 2 ) ( 2 H + 1 )}$$

We remark that the computed volatility is the volatility on the Δt time scale. The local volatility on the time scale τ=mΔt is \hat{σ}(tₙ₀)m^{Ĥ(t}^{ₙ₀}⁾.

Boundary Center Times

The spectral information can also be computed for center-time index n0∈{1, . . . , M/2−1}∪{N−M+M/2+1, . . . , N}, but this requires narrowing the time window used to estimate the local power law parameters. For n0∈{1, . . . , M/2−1}, we can apply the algorithm for interior center times up to the following modifications. First, we replace M by \tilde{M}=n₀−└M/2┘+M. Second, we replace the data vector Q in Eq. (1) by \tilde{Q}=(\tilde{Q}ⱼ)ⱼ₌₁^{\tilde{M}} data defined by

\tilde{Q}ⱼ=log(P(tⱼ)), j=1, . . . ,\tilde{M}

The center times n0∈{N−M+M/2+1, . . . , N} can be treated similarly.

### SUMMARY

We make explicit the dependence on the inertial range and time window ji, je, M. The result of the above procedure is the following. For a given time series of prices {P(tn),n=1, . . . , N}, for each center time tn0, n0∈{1, . . . , N}, we obtain the associated scale spectrum, the local Hurst exponent and the local volatility:

S(j,tₙ₀,M), j∈{jᵢ, . . . ,jₑ},

Ĥ(tₙ₀;jᵢ,jₑ,M), \hat{σ}(tₙ₀;jᵢ,jₑ,M).

The time window's size M was chosen according to the scale of information we wanted to probe. In FIG. 3, we chose to include the full time series in which case we obtain the “global” scale spectral model. In FIG. 4, we chose M=2⁸ to resolve the local variations in the Hurst exponent and volatility. Similarly, the inertial range jᵢ, jₑ was chosen to select the scales for which we are looking for a power law. For the examples given in this paper, we used jᵢ=1 and jₑ=M/2. This is the maximum inertial range given the window size. If the data exhibit a power law only in a limited inertial range, then indeed jᵢ, jₑ would be chosen accordingly. We also remark that the inertial range and the time window's size can be chosen via an automatized procedure. For instance, by choosing several window sizes to get an a priori estimate of the local scale of variation of the parameters, σ, H, we can subsequently choose a local window size to maximize a signal-to-noise ratio. Similarly, the inertial range, given a time window's size M, can be chosen as the maximal inertial range for which the fitting residual conforms with the one associated with a Gaussian model.

It will be understood that various modifications can be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

1. A method comprising:
in a computer system having at least a processor and a memory, the memory having at least an operating system, using wavelets to form a scale spectrum; and
computing estimated Hurst and volatility parameters derived from the scale spectrum.

2. The method of claim 1 wherein the wavelets are selected from the group consisting of Harr wavelets and Daubechies wavelets.

3. The method of claim 1 wherein Hurst exponent and volatility parameters jointly describe a statistical character of data vectors possessing local power law spectra.

4. A method comprising:
in a computer systems having at least a processor and a memory, the memory having at least an operating system, computing Haar wavelet coefficients, the Haar wavelet coefficients representing local averages of a data vector, the computing done at all possible averaging lengths and all possible center points for an averaging window;
for each location of the window, computing an energy (mean square value) of the Haar coefficients whose center points are within the window, computing the energy (mean square value) of the Haar coefficients determined separately for each group of Haar coefficients, based on a certain averaging length, the energy as a function of the Haar coefficient averaging length referred to as a scale spectrum; and
computing Hurst coefficient and volatility as a function of the moving window's center point derived from a slope and an intercept of the scale spectrum in a log-log plot.

5. The method of claim 4 wherein the scale spectrum in the log-log plot is a log energy of the Haar coefficients as a function of the log of the averaging length for the Haar coefficients.

6. An architecture comprising:
a network of interconnected computers; and
a link from the network to a computing device, the computing device having at least a processor and a memory, the memory having at least an operating system and a process to determine for jointly estimating a Hurst exponent and a volatility of time series, the process comprising:
computing Haar wavelet coefficients, the Haar wavelet coefficients representing local averages of a data vector, the computing done at all possible averaging lengths and all possible center points for an averaging window;
for each location of the window, computing an energy (mean square value) of the Haar coefficients whose center points are within the window, computing the energy (mean square value) of the Haar coefficients determined separately for each group of Haar coefficients, based on a certain averaging length, the energy as a function of the Haar coefficient averaging length referred to as a scale spectrum; and
computing Hurst coefficient and volatility as a function of the moving window's center point derived from a slope and an intercept of the scale spectrum in a log-log plot.
